(19) United States
(12) Patent Application Publication
(10) Pub. No.: US 2024/0362910 A1
(43) Pub. Date: Oct. 31, 2024

(54) SYSTEM AND METHODS FOR AGRICULTURAL SIMULATION AND ANALYSIS

(71) Applicant: Microsoft Technology Licensing, LLC, Redmond, WA (US)

(72) Inventors: Nishant CHANDRA, Bangalore (IN); Anand MOOGA, Secunderabad (IN); Dinesh Ram MATTAPALLI, Hyderabad (IN)

(21) Appl. No.: 18/307,764

(22) Filed: Apr. 26, 2023

(51) Int. Cl. G06V 20/10; G06Q 50/02; G06V 10/143

(52) U.S. Cl. CPC G06V 20/188; G06Q 50/02; G06V 10/143

(57) ABSTRACT

Described herein are various technologies pertaining to an agricultural analysis system for simulating various aspects of the agricultural process. Specifically, an agricultural analysis application is provided that receives target crop growth parameters representative of desired outcomes for a particular crop and a crop growth location indicative of the area to be analyzed by the agricultural analysis application. The agricultural analysis application then identifies satellite image data of the crop growth location and uses the real satellite image data to generate simulated satellite image data using a canopy reflectance simulator. The agricultural analysis application then determines certain parameters that, when provided as input into the canopy reflectance simulator, cause the generated simulated satellite image data to correspond the real satellite image data. The determined parameters are therefore indicative of the parameters that likely lead to the observed crop conditions present in the real satellite image data. The agricultural analysis application then uses a crop growth simulator to determine simulated crop growth input parameters that, when provided as input into the crop growth simulator, cause the crop growth simulator to generate output that corresponds to at least one of the target crop growth parameters received by the agricultural analysis application. The determined simulated crop growth input parameters are therefore indicative of the parameters that would likely lead to the desired target crop growth parameters in practice.

### BACKGROUND

Prevailing population trends have led to substantial increases in worldwide demand for food and produce products. Climate features and shrinking rural workforce have strained the ability of the agricultural sector to generate a sufficient supply of crops to meet the increasing demand. A diminished supply capacity means that supply chain disruptions can result in catastrophic food shortages and other major problems in the agricultural industry.

Sustainable farming practices have been proposed to increase farm efficiency and generate greater output of agricultural products. Sustainable farming can be broken down into two major parts: 1) use of better technology and equipment to produce increased output; and 2) modification of conventional farming methods and decision making at the farm level to better utilize resources and increase output. However, due to the many different parameters and decisions that go into each crop between planting and harvesting, as well as the extended amount of time needed to observe and evaluate the effect of different agricultural methods' result on the ultimate crop yield, efficiency gains in sustainable farming can take many years to be realized through trial and error.

Agronomists have developed computer-implemented modeling systems to simulate how certain crops may grow under certain conditions. These conventional modeling systems rely on several different models which are only configured to simulate a narrow aspect of the agricultural process. Human intervention is then required to interpret how the output can be applied to decision making at the farm level. These conventional modeling systems further rely on publicly available agricultural data which can be incomplete, inaccurate, or difficult to access. While conventional technologies may provide a partial picture of anticipated crop growth and yield, the disparate nature of the models used means that conventional systems are unable to provide a holistic view of the entire agricultural process.

### SUMMARY

The following is a brief summary of subject matter that is described in greater detail herein. This summary is not intended to be limiting as to the scope of the claims.

Described herein are various technologies pertaining to an agricultural analysis system for simulating various aspects of the agricultural process in a unified manner. Specifically, the system comprises an agricultural analysis application that is configured to simulate satellite images, vegetative and growth characteristics of crops, biomass, yield, and effects of different soil, irrigation methods, and fertilizer use over multiple crop seasons. The agricultural analysis application can be utilized to optimize land usage to obtain an improved yield of produce, to enhance decision making around crop rotation, evaluate seed variant efficacy, and estimate commodity pricing around each crop.

In a nonlimiting example, a server computing system comprises a processor and a memory having a server agricultural analysis application stored thereon. When the server agricultural analysis application is executed by the processor, the server agricultural analysis application performs certain agricultural analysis actions as described herein. In certain embodiments, the agricultural analysis application is a distributed application having both server-side functionality (e.g., via a server agricultural analysis application) and client-side functionality (e.g., via a client agricultural analysis application).

The agricultural analysis application performs analysis of a crop growth location according to certain target crop growth parameters. The agricultural analysis application receives the target crop growth parameters and the crop growth location, for example, from a client agricultural analysis application executing on a client computing system. The target crop growth parameters may relate to certain desired characteristics of crop growth, such as crop yield, biomass, and/or water consumption. The crop growth location is a location where crop growth is to be analyzed by the agricultural analysis application. More specifically, the crop growth location defines a bounded area to be analyzed by the agricultural analysis application. The crop growth location may be defined by longitude and latitude coordinates. For example, the crop growth location may relate to a specific plot or plots of land, such as would be operated by a family farming operation. In another example, the crop growth location may be an entire county, state, region, or country, etc., which is representative of a larger section of the agricultural sector.

Responsive to receiving the target crop growth parameters and the crop growth location, the agricultural analysis application obtains satellite image data of the crop growth location. The satellite image data is observed from one or more satellites configured to capture arial images of land masses around the world. Observed satellite data may also be referred to herein as “real satellite data” as opposed to other types of satellite data, such as, for example, simulated satellite data. The real satellite image data is stored in a data store accessible to the server computing device over a network, such as the Internet. Each satellite generating the satellite image data may be configured with one or more cameras operable to capture images in different electromagnetic spectral bands. For example, satellite image data may comprise a plurality of spectral bands, such as, for example, visible blue-green (475-575 nm), visible orange-red (580-680 nm), and visible red to near-infrared (690-830 nm).

The agricultural analysis application analyzes the satellite data to determine time-series measurements of the satellite data. The time-series measurements are an observation of the satellite image data over a period of time. Typically, conventional systems are limited to analyzing satellite data according to snapshots of an observation area. The agricultural analysis application is further configured to determine time-series measurements of the satellite data for each spectral band captured by the satellite.

In performing further analysis of the satellite image data, the agricultural analysis application may then calculate a leaf area index for each of the spectral bands using the time-series measurements. The leaf area index characterizes the amount of plant canopy in the image data which is indicative of the maturity of certain plants. The agricultural analysis application uses the leaf area index over the time-series image data to determine a growth rate of plants in the observed image data. By analyzing the entire time-series of an isolated satellite spectra, the agricultural analysis application creates a more deterministic view of crop growth from seed planting to germination to harvest.

The agricultural analysis application further comprises a canopy reflectance simulator configured to generate simulated satellite image data. The agricultural analysis application inputs certain parameters into the canopy reflectance simulator to generate the simulated satellite image data. In certain embodiments, the agricultural analysis application is configured to estimate input parameters into the canopy reflectance simulator such that the simulated satellite image data output of the canopy reflectance simulator is substantially similar to the satellite image data of the crop growth location that the agricultural analysis application previously identified.

In an example, the agricultural analysis application uses the calculated leaf area index of each of the spectral bands of the real satellite image data as input into the canopy reflectance simulator. The leaf area index (as calculated by the agricultural analysis application) is based on time-series measurements of each band. The output of the canopy reflectance simulator is then compared to the real satellite image data and the inputs into the canopy reflectance simulator are adjusted by the agricultural analysis application until the simulated satellite image data is substantially similar to the real satellite image data. For example, the agricultural analysis application determines that the simulated satellite image data is substantially similar to the real satellite image data when one or more time-series measurements of the simulated satellite image data match corresponding time-series measurements of the real satellite image data. In an example, the generated satellite image data is substantially similar to the real satellite image data when an entire time-series measurement of the simulated satellite image data in a first spectral band matches an entire time-series measurement of the real satellite image data in a corresponding spectral band.

The agricultural analysis application further comprises a crop growth simulator. The crop growth simulator is configured to simulate crop growth over a period of time under certain crop growth input parameters, such as specific soil conditions, climate conditions, etc. The agricultural analysis application is configured to determine input parameters for the crop growth simulator that will produce an output that corresponds with at least one of the target crop growth parameters received by the agricultural analysis application. To accomplish this, the agricultural analysis application estimates initial input parameters and provides the estimated input parameters as input into the crop growth simulator. The crop growth simulator then generates simulated crop growth output based on the initial input parameters. The agricultural analysis application then compares the simulated crop growth output to the simulated canopy reflectance parameters. The agricultural analysis application modifies the initial input parameters into the crop growth simulator until it determines simulated crop growth input parameters that correspond to the target crop growth parameters.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of an exemplary agricultural analysis system.

FIG. 2A is an exemplary process flow diagram illustrating the determination of simulated canopy reflectance parameters by an agricultural analysis application.

FIG. 2B is an exemplary process flow diagram illustrating the determination of simulated crop growth input parameters for a crop growth simulator.

FIG. 3 is a flow diagram that illustrates an example methodology for performing agricultural analysis.

FIG. 4 is an exemplary computing system.

### DETAILED DESCRIPTION

Various technologies pertaining to an agricultural analysis application are now described with reference to the drawings, where like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component”, “system”, “module”, and “model” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Described herein are various technologies pertaining to an agricultural analysis system for simulating various aspects of the agricultural process in a unified manner to inform implementation of sustainable farming practices and improve agricultural output. Specifically, the system comprises an agricultural analysis application that is configured to simulate satellite images, vegetative and growth characteristics of crops, biomass, yield, and effects of different soil, irrigation methods, and fertilizer use over multiple crop seasons. The agricultural analysis application can be utilized to optimize land usage to obtain an improved yield of produce, to enhance decision making around crop rotation, evaluate seed variant efficacy, and estimate commodity pricing around each crop.

A deficiency of conventional systems is that they are only configured to simulate narrow aspects of the agricultural process and are often reliant on data that is incomplete, inaccurate, or difficult to obtain data. This contributes to a failure of conventional systems to provide useful insight into the agricultural production process as a whole. The technologies described herein overcome the deficiencies of conventional systems by providing a holistic analysis tool capable of simulating the effects of sustainable farming practices applied at a scalable level. Furthermore, the technologies described herein enable analysis of the entire agricultural process from seed selection, to planting, to harvest, which can inform decision making and improve the efficiency of individual farms or even the agricultural sector as a whole.

In an exemplary embodiment, an agricultural analysis application is configured to receive target crop growth parameters representative of desired outcomes for a particular crop. The agricultural analysis application additionally receives a crop growth location indicative of the area to be analyzed by the agricultural analysis application. The agricultural analysis application then identifies satellite image data of the crop growth location and uses the real satellite image data to generate simulated satellite image data using a canopy reflectance simulator. The agricultural analysis application then determines certain parameters that, when provided as input into the canopy reflectance simulator, cause the generated simulated satellite image data to correspond the real satellite image data. The determined parameters are therefore indicative of the parameters that likely lead to the observed crop conditions present in the real satellite image data.

The agricultural analysis application uses a crop growth simulator to determine simulated crop growth input parameters that, when provided as input into the crop growth simulator, cause the crop growth simulator to generate output that corresponds to at least one of the target crop growth parameters received by the agricultural analysis application. The determined simulated crop growth input parameters are therefore indicative of the parameters that would likely lead to the desired target crop growth parameters in practice.

These technologies are described in greater detail herein.

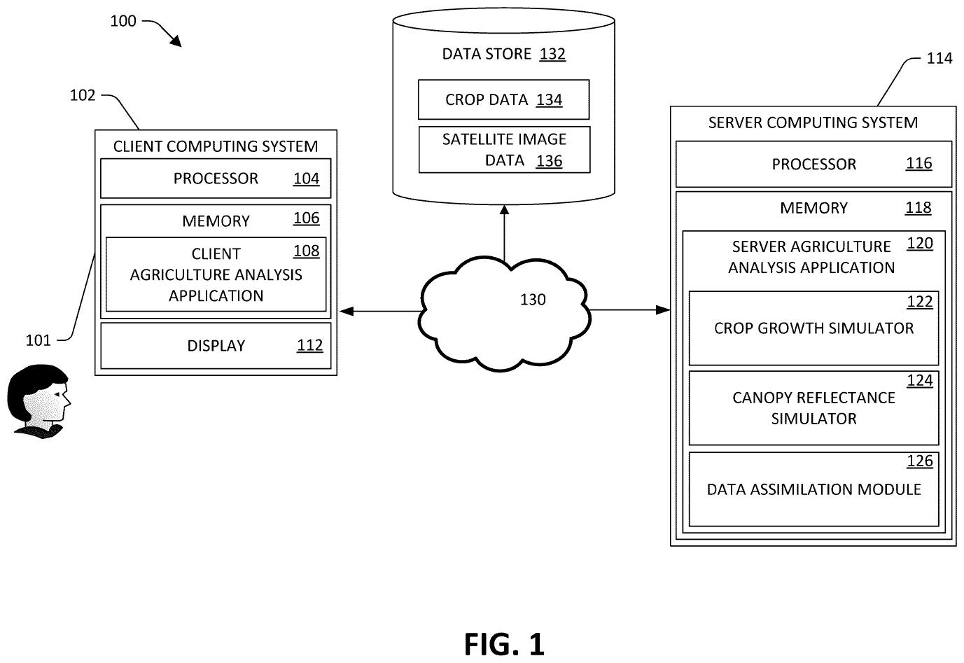

Referring now to FIG. 1, a functional block diagram of an agricultural analysis system 100 is depicted. The system 100 comprises a client computing system 102 in data communication with a server computing system 114 by way of network 130 (e.g., the Internet). Client computing system 102 may be any suitable type of client computing device, including a desktop computing device, a laptop computing device, a tablet computing device, a mobile telephone, etc. The client computing system 102 comprises a processor 104, a memory 106 and a display 112. The memory 106 stores instructions that are executed by the processor 104. More specifically, the memory 106 has loaded therein a client agricultural analysis application 108.

The client agricultural analysis application 108 is operated by user 101. Client agricultural analysis application 108 may comprise one or more user-selectable personas that configure the client agricultural analysis application 108 for certain tasks that correspond to certain target crop growth parameters and/or crop growth locations associated with the persona. For example, client agricultural analysis application 108 may be configured with a procurement manager persona. A procurement manage persona may be associated with certain seed variety input parameters the correspond to production parameters associated with a product or sector associated with the procurement persona. In an example, selection of a potato chip procurement manager persona would configure the client agricultural analysis application 108 to analyze factors surrounding the agricultural output of potatoes.

As another example, client agricultural analysis application 108 may be configured with a seed evaluator persona. A seed evaluator persona may be associated with certain seed variety input parameters the correspond to seed evaluation parameters associated testing and evaluation of different seed varieties. In an example, selection of a seed evaluator persona would configure the client agricultural analysis application 108 to analyze factors surrounding the breeding, selection, testing, certification, quality control, and release of seed varieties.

System 100 further comprises a server computing system 114 for implementing the agricultural analysis disclosed herein. The server computing system 114 comprises a processor 116 and a memory 118. Memory 118 has a server agricultural analysis application 120 installed thereon, such that when the application 120 is executed by processor 116, the application 120 performs agricultural analysis activities. The server agricultural analysis application 120 is configured to simulate satellite images, vegetative and growth characteristics of crops, biomass, yield, and effects of different soil, irrigation methods, and fertilizer use over multiple crop seasons. The server agricultural analysis application 120 can be utilized to optimize land usage to obtain an improved yield of produce, to enhance decision making around crop rotation, evaluate seed variant efficacy, and estimate commodity pricing around each crop.

The server agricultural analysis application 120 comprises a crop growth simulator 122. Crop growth simulator 122 is configured to simulate crop growth given certain input parameters, such as specific soil and climate conditions. An exemplary listing of input parameters for crop growth simulator 122 are illustrated in Table 1:

TABLE 1

| Parameter | Range | | Description |
|---|---|---|---|
| Crop | — | | Crop variant |
| Planting Date | — | | Planting date corresponding to the crop variety |
| | | | and season |
| Soil type | — | | Soil variant |
| Soil wetness | 0-1 | | Soil moisture (WAV parameter) |
| Soil Rooting | 10-150 | cm | Maximum rooting depth allowed by soil (cm) |
| Depth | | | |
| NBase, PBase, | 0-100 | kg ha − 1 | Basic supply of nitrogen/phosphorous/potassium |
| KBase | | | by the unfertilized soil |
| Weather Data | — | | Real weather data using longitude and latitude |
| Irrigation | 0-10 | cm | Frequency of irrigation events can be either |
| events | | | periodic or aperiodic |
| Fertilization | 0-100 | kg ha − 1 | Frequency of fertilization of NPK events can be |
| events | | | either periodic or aperiodic |
| Emergence | 50-200 | C. | Temperature sum for emergence |
| GDD | | | |
| Ko | 0.1-100 | Cm day − 1 | Hydraulic conductivity of saturated soil. |

In certain embodiments, the crop growth simulator 122 is configured to simulate annual crop growth at a daily time-step according to the combination of input parameters applied to the simulator. The crop growth simulator 122 is configured to calculate attainable crop production, biomass, water use, etc., for a location given input parameters such as soil type, crop type, weather data, and crop management factors (e.g., sowing date). Additional input parameters are identified above in Table 1. In an example, the crop growth simulator 122 is based on the World Food Studies Simulation Model (WOFOST).

The server agricultural analysis application 120 further comprises a canopy reflectance simulator 124. Canopy reflectance simulator 124 is configured to simulate vegetation canopy reflectance spectra under different input conditions by generating simulated satellite image data. The simulated satellite image data generated by the canopy reflectance simulator 124 is indicative of leaf canopy conditions that would result if the input conditions were applied in an actual agricultural setting. By comparing simulated output of the canopy reflectance simulator 124 with observed satellite data (e.g., satellite image data 136), the server agricultural analysis application 120 is able to use simulation to determine input parameters that, when put into practice in an actual agricultural setting, would produce common canopy characteristics with the observed satellite data.

The server agricultural analysis application 120 determines input parameters for the canopy reflectance simulator 124 that correspond to certain target crop growth parameters by comparing the simulated satellite image data to real satellite image data (e.g., satellite image data 136). In an example, the server agricultural analysis application 120 utilizes data assimilation module 126 to compare the simulated satellite image data to the real satellite image data and adjust parameters into the canopy reflectance simulator 124 until data convergence, i.e., the real satellite image data and the simulated satellite image data are substantially similar. In an example, substantial similarity between the simulated satellite image data and the real satellite image data is achieved when one or more time-series measurements of the simulated satellite image data match corresponding time-series measurements of the real satellite image data. For example, the generated satellite image data is substantially similar to the real satellite image data when an entire time-series measurement of the simulated satellite image data in a first spectral band matches an entire time-series measurement of the real satellite image data in a corresponding spectral band. It is appreciated that in certain embodiments substantial similarity may be determined in a more or less strict manner, for example, by requiring that the entire time-series measurement of the simulated satellite image data for each available spectral band matches an entire time-series measurement of the real satellite image data in all corresponding spectral bands. In certain embodiments, the canopy reflectance simulator 124 is based on a PROSAIL model, which is a combination of the PROSPECT leaf optical properties model and the SAIL canopy reflectance model. Exemplary input parameters for the canopy reflectance simulator 124 are illustrated in Table 2:

TABLE 2

| Parameter | Value |
|---|---|
| Chlorophyll a and b content (Cab) | 40 |
| Carotenoid content (Car) | 12.3 |
| Brown pigment content (Cbrown) | 0 |
| Leaf water content (Cw) | 0.015 |
| Leaf dry matter content (Cm) | 0.0055 |
| Structure coefficient (N) | 1.5 |
| Leaf angle distribution (LIDF) | Spherical |
| Leaf area index (LAI) | 0.1, 0.5, 1, 2, 3, 4, 5 |
| Solar zenith angle (tts) | 20, 30, 40, 50, 60 |
| Observer zenith angle (tto) | 0 |
| Azimuth (psi) | 0 |
| Soil reflectance properties (psoil) | 0.7 |

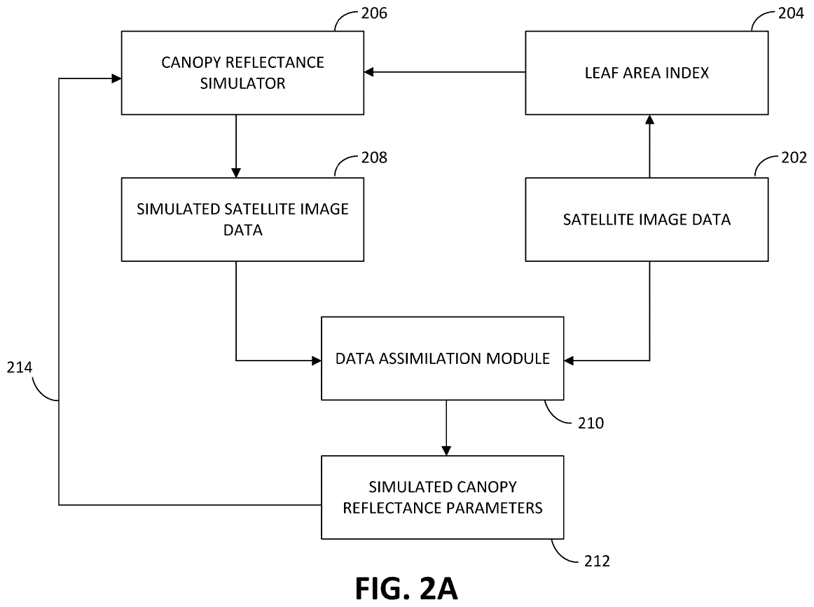

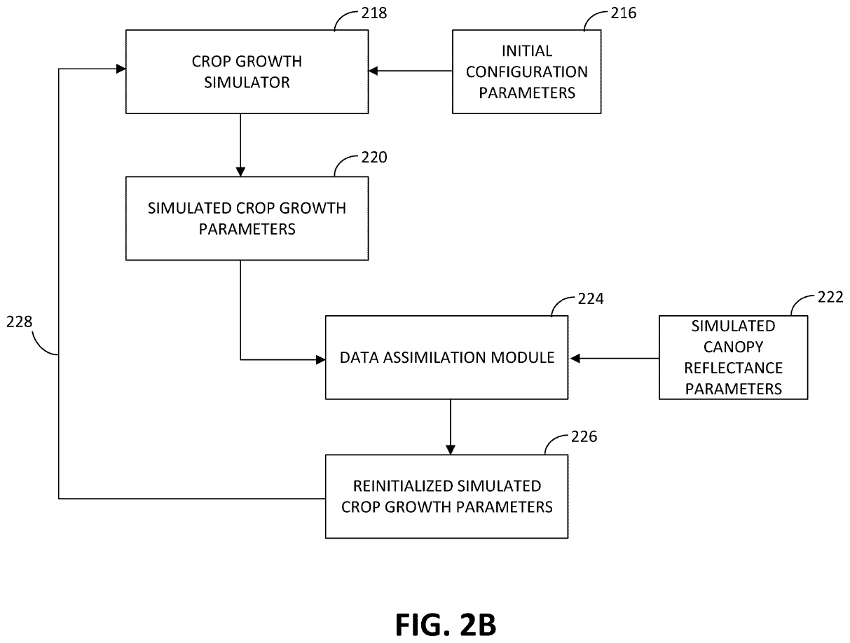

As previously mentioned, the server agricultural analysis application 120 further comprises a data assimilation module 126. The server agricultural analysis application 120 utilizes data assimilation module 126 to perform data assimilation in connection with the crop growth simulator 122 and the canopy reflectance simulator 124. The data assimilation module 126 can forecast initial input conditions and apply correction to the input conditions based on observed data. In some embodiments, the data assimilation module 126 receives multiple input configurations in parallel in order to determine input conditions that correspond to observed output of the data assimilation module 126. This process will be described in more detail with regard to the determination of simulated canopy reflectance parameters illustrated in FIG. 2A and the determination of simulated crop growth input parameters for a crop growth simulator illustrated in FIG. 2B.

The system further comprises a data store 132. Data store 132 receives data from the client computing system 102 and the server computing system 114, for example, over network 130. While depicted as a single entity, it is appreciated that data store 132 may be distributed in nature, comprising many different data storages connected over a network, such as the Internet. Data store 132 comprises crop data 134 which describes historical crop use over time. In an example, crop data 134 comprises data relating to historical weather data, seed data, soil data, etc.

Data store 132 further comprises satellite image data 136. Satellite image data 136 comprises satellite image data observed from one or more satellites configured to capture arial images of landmasses around the world. Satellite image data 136 may also be referred to herein as “real satellite data.” Each satellite generating the satellite image data 136 may be configured with one or more cameras operable to capture images in different electromagnetic spectral bands. For example, satellite image data may comprise a plurality of spectral bands, such as, for example, visible blue-green (475-575 nm), visible orange-red (580-680 nm), and visible red to near-infrared (690-830 nm). In some embodiments, the satellite image data 202 comprises image data from the Copernicus SENTINEL-2 Satellite. In another embodiment, the satellite image data 202 comprises image data from the Landsat 2 Satellite. It is appreciated that satellite image data 202 may comprise satellite image data from a variety of satellite image sources.

With continued reference to FIG. 1, exemplary operation of the agricultural analysis system 100 is now described. When the server agricultural analysis application 120 is executed by processor 116, the server agricultural analysis application 120 is configured to perform certain agricultural analysis actions as described herein. Specifically, the server agricultural analysis application 120 receives input data from a client agricultural analysis application 108 executing on a client computing system 102. The input data may comprise a crop growth location and one or more target crop growth parameters. The crop growth location is a location where crop growth is to be analyzed by the server agricultural analysis application 120. In an example, the server agricultural analysis application 120 receives only a crop growth location. The sever agricultural analysis application can then be used to perform an open-ended analysis of the crop growth area.

The crop growth location defines an area to be analyzed by the server agricultural analysis application 120. The crop growth location may be further defined by certain longitude and latitude. In an example, the crop growth location relates to a specific farm plot of land. In another example, the crop growth location may be an entire county, state, region, or country, etc. The target crop growth parameters may relate to certain desired characteristics of crop growth, such as crop yield, biomass, and/or water consumption. The target crop growth parameters further inform the server agricultural analysis application 120 and may reduce the number of parameters needed to be analyzed by the server agricultural analysis application, which can further improve the computational efficiency of system 100.

Responsive to receiving the target crop growth parameters and/or the crop growth location, the server agricultural analysis application 120 determines simulated canopy reflectance parameters. This process is illustrated in FIG. 2A.

With continued reference to FIG. 1, and additional reference to FIG. 2A, the process by which the server agricultural analysis application 120 may determine simulated canopy reflectance parameters that correspond to real satellite data is provided. At step 202, the server agricultural analysis application 120 identifies and retrieves satellite image data 136 (e.g., from the data store 132 over network 130). The satellite image data 136 may relate to a crop growth location received by the server agricultural analysis application 120. At step 204, the server agricultural analysis application 120 then analyzes the satellite image data 132 to calculate a leaf area index for the satellite image data 132. In an example, the server agricultural analysis application 120 determines time-series measurements of the satellite image data 132 for each spectral band of the satellite image data. The leaf area index characterizes the amount of plant canopy in the image data which is indicative of the maturity of certain plants. The server agricultural analysis application 120 may use the leaf area index over the time-series image data to determine a growth rate of plants in the observed image data.

At step 206, the server agricultural analysis application 120 provides the leaf area index data as input into the canopy reflectance simulator 124 which generates simulated satellite image data at step 208. As explained above, the leaf area index data is representative of a time-series measurement of a spectral band of the satellite image data. This provides an advantage over conventional systems which typically only provide individual snapshot image input to a canopy reflectance simulator. At step 210, the server agricultural analysis application 120 then uses data assimilation module 210 to determine simulated canopy reflectance parameters by estimating input parameters to the canopy reflectance simulator 124 and modifying the estimated input parameters until the simulated satellite image data is substantially similar to the real satellite image data. In an example, substantial similarity between the simulated satellite image data and the real satellite image data is achieved when one or more time-series measurements of the simulated satellite image data match corresponding time-series measurements of the real satellite image data. As a further example, substantial similarity may be determined when a time-series measurement of the simulated satellite image data in the visible blue-green spectral band matches the time-series measurement of the real satellite image data in the same visible blue-green spectral band. The simulated canopy reflectance parameters are output at step 212. After each iteration of the data assimilation module, the simulated canopy reflectance parameters are provided back as input into the canopy reflectance simulator at step 214. The process is repeated until the simulated canopy reflectance parameters are provided as input into the canopy reflectance simulator 124 and the canopy reflectance simulator 124 generates simulated satellite data substantially similar to the real satellite image data 136.

The exemplary operation of the agricultural analysis system 100 is now further described with reference to FIG. 2B. At step 216, the server agricultural analysis application 120 receives one or more initial configuration parameters for crop growth simulator 122. It is an object of server agricultural analysis application 120 to determine additional configuration parameters that, when provided as input into the crop growth simulator 122 cause the simulator to generate simulated crop growth output parameters that correspond to at least one of the target crop growth parameters received by the server agricultural analysis application 120. In some embodiments, some initial configuration parameters are provided by an operator of client agricultural analysis application 108, such as, for example, according to a persona. Exemplary initial configuration parameters for crop growth simulator 122 are provided in Table 1. In some embodiments, the server agricultural analysis application 120 may estimate one or more of the initial configuration parameters.

At step 218, initial configuration parameters are provided to the crop growth simulator 122. The crop growth simulator 122 is configured to simulate crop growth over a period of time under the initial configuration parameters (e.g., specific soil conditions, climate conditions, etc.). At step 220, the crop growth simulator 122 generates simulated crop growth output parameters based on the initial input parameters. At step 222, the agricultural analysis application 120 retrieves the simulated canopy reflectance parameters from FIG. 2A.

At step 224, the agricultural analysis application 120 then uses data assimilation module 126 to compare the simulated crop growth output to the simulated canopy reflectance parameters. Reinitialized simulated crop growth parameters are generated at step 226. At step 228, reinitialized simulated crop growth parameters are provided to the crop growth simulator and the process is repeated until the server agricultural analysis application 120 determines simulated crop growth input parameters that correspond to the target crop growth parameters. In certain embodiments the process illustrated in FIG. 2B can be repeated by a plurality of simultaneous worker threads which increases the computational efficiency of system 100 and decreases the amount of time until determination of simulated crop growth parameters that correspond to the target crop growth parameters. It is appreciated that each simultaneous worker thread is operable to initiate different permutations of input parameters.

The benefits of the agricultural analysis application 120 will now be further described with reference to several examples.

### Example 1: Procurement Manager

A procurement manager in a seed company that produces fast-moving consumer goods (FMCG) like potato chips has a number of responsibilities related to sourcing and acquiring the raw agricultural materials necessary for production of potato chips. Some of the key steps in this journey could include:

Identifying the specific seed varieties and quantities needed for production: The procurement manager would need to work closely with the production team to understand the specific seed varieties and quantities required for producing the FMCG products. They would also need to take into account any seasonal variations in demand.

Sourcing suppliers: The procurement manager would need to research and identify potential suppliers for the seed varieties needed. They would need to evaluate the suppliers' ability to meet the company's quality, quantity, and delivery requirements. They would also need to negotiate prices and contract terms with the suppliers.

Managing inventory: The procurement manager would need to ensure that the company has adequate inventory of seed varieties on hand to meet production needs. They would need to track inventory levels and order new seed varieties as needed to avoid stockouts.

Monitoring supplier performance: The procurement manager would need to monitor supplier performance to ensure that they are meeting the company's expectations in terms of quality, delivery, and price. They would need to address any issues that arise and take action as needed to maintain a good working relationship with the suppliers.

Managing logistics: The procurement manager would need to handle the logistics of getting the seed varieties from the suppliers to the company's warehouses or production facilities. This would include coordinating transportation, customs clearance, and other logistics-related activities.

Managing data and reporting: The procurement manager would need to maintain accurate records of all seed purchasing activities, including purchase orders, invoices, and delivery receipts. They would also need to prepare reports on seed purchasing activities for management and other stakeholders.

One of the major concerns for a procurement manager in a seed company is the availability and proximity of production plants to seed production sites. This is because the availability and proximity of production plants can have a significant impact on the overall efficiency and cost-effectiveness of the seed production process.

If production plants are located far from seed production sites, it can add additional transportation costs and lead-time to the seed production process. This can increase the overall cost of production and may also impact the quality of seed, as it may be exposed to different temperatures and humidity during the transportation. Additionally, the further the production plants are located from the seed production sites, the more difficult it can be for the procurement manager to closely monitor and manage the production process.

On the other hand, if production plants are located close to seed production sites, it can greatly reduce transportation costs and lead-time, as well as make it easier for the procurement manager to closely monitor and manage the production process. This can also help to maintain the quality of the seed and ensure that it meets the company's standards.

Additionally, the availability of production plants is also an important factor to consider. If the production plants are not available, it can lead to delays in the production process and may also result in additional costs for the company. Therefore, the procurement manager needs to closely monitor the availability of production plants and plan accordingly to ensure that production can proceed smoothly and efficiently.

The role of a procurement manager in a seed company involves a lot of responsibility and challenges. One of the key challenges is to optimize the seed production process in order to maximize profits. To accomplish this, the procurement manager needs to take a holistic approach and consider all the various components of the production process.

To plan accordingly and optimize profits is a challenging task, but it can be improved by properly timing the date of planting and date of harvest for each of the seed production sites. This takes into account various factors such as weather conditions, which can greatly impact the success of the seed production process.

In the above scenario, a procurement manager could use the agriculture analysis application to estimate parameters such as seed characteristics, management practices, weather, and soil. By utilizing the agriculture analysis application, the procurement manager can gain a more comprehensive understanding of the seed production process and make more informed decisions about how to optimize it.

The agriculture analysis application can estimate the yield of different seed varieties under different weather conditions, and identify the best planting and harvest dates for each seed production site. Additionally, the agriculture analysis application can also help to optimize the use of resources such as land, seed, and human resources, which can greatly impact the overall cost-effectiveness of the agricultural production process.

### Example 2: Seed Evaluator

Seed companies go through a rigorous testing process to generate new seed varieties. This process typically includes several steps:

Breeding: Plant breeders develop new seed varieties by crossbreeding different plants to create offspring with desirable traits, such as improved yield, disease resistance, or tolerance to harsh environmental conditions.

Selection: The best plants from the breeding process are selected based on their desired traits and are then used to produce the next generation of seeds.

Testing: The new seed varieties are then tested in controlled greenhouse and field trials to evaluate their performance, such as germination rate, growth rate, and yield.

Certification: Seed companies must obtain certifications from relevant government agencies to ensure that their seed varieties meet certain standards and are fit for sale to farmers.

Quality Control: Finally, the seed company will conduct a quality control process on the produced seed before it is packaged and shipped to farmers.

Release: After passing all the above stages, the new seed variety is released for sale to farmers.

The process of bringing a seed product to market from the lab is a long and complex one that typically takes an average of 12 years. A major portion of this time is dedicated to testing the seed in controlled greenhouse environments and in field trials. The initial stage of testing involves evaluating thousands of potential seed candidates under different treatment conditions using a small sample size. The successful candidates, which are usually a much smaller number, move on to the next stage of testing where they are evaluated under even more treatment conditions using a larger sample size in the next growing season.

This process continues over multiple growing seasons, with the sample size gradually increasing as the number of successful candidates decreases. The whole process is resource-intensive, requiring large amounts of land, seed, human resources, and other resources, which can be costly. Despite all the rigorous testing, even after all the testing, there is no guarantee that the final product will be successful in the market.

The testing process is highly regulated and follows strict guidelines to ensure that the seed is safe and effective for use. The testing process also involves multiple stages of field trials, which are conducted under different environmental conditions, to ensure that the seed can withstand a range of growing conditions. Additionally, the seed is tested for its yield, disease resistance, and adaptability to different climates. After all the testing is done the seed is then subject to regulatory approval and only then it is allowed to go to market.

The agriculture analysis application provides simulation insight allowing the utilization of resources effectively and identifying potential issues with certain seeds early in the process. For example, by gathering satellite data during the initial field trial of a seed candidate the agriculture analysis application can provide valuable information on factors such as plant growth and development, crop health, and weather conditions.

The agriculture analysis application also estimates parameters such as seed characteristics, management practices, weather, and soil. By utilizing the agriculture analysis application, a more comprehensive understanding of the seed candidate and its potential performance is gained.

In addition, the agriculture analysis application can simulate hypothetical scenarios where the seed has not yet been evaluated in the field. This may include potential use cases from farmers, as well as locations that seed companies typically test. By simulating these scenarios using the agriculture analysis application, a better understanding of the seed's potential performance in different conditions is gained.

Further, agriculture analysis application the seeds based on maximizing the required traits like yield. By focusing on maximizing yield, server agricultural analysis application 120 is able to identify seed candidates that have the greatest potential for success in the market. Overall, a fail-fast approach aims to optimize the use of resources and increase the chances of success for the final product.

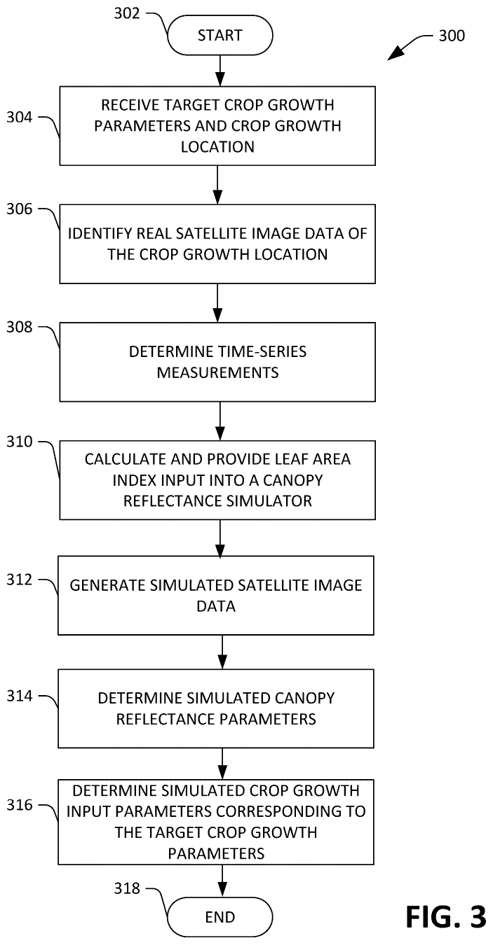

FIG. 3 is a flow diagram that illustrates an example methodology for agricultural analysis as disclose herein. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring now to FIG. 3, a flow diagram that illustrates an example methodology 300 for performing the agricultural analysis techniques disclosed herein. At step 302, the methodology 300 begins. At step 304, the agricultural analysis application receives the target crop growth parameters and the crop growth location, for example. The target crop growth parameters may relate to certain desired characteristics of crop growth, such as crop yield, biomass, and/or water consumption. The crop growth location is a location where crop growth is to be analyzed by the agricultural analysis application.

At step 306, responsive to receiving the target crop growth parameters and the crop growth location, the agricultural analysis application identifies real satellite image data of the crop growth location. The satellite image data is observed from one or more satellites configured to capture arial images of landmasses around the world.

At step 308, the agricultural analysis application analyzes the satellite data to determine time-series measurements of the satellite data. The time-series measurements are an observation of the satellite image data over a period of time. The agricultural analysis application is further configured to determine time-series measurements of the satellite data for each spectral band captured by the satellite.

At step 310, the agricultural analysis application calculates a leaf area index for each of the spectral bands of the real satellite image data using the time-series measurements. The leaf area index characterizes the amount of plant canopy in the image data which is indicative of the maturity of certain plants. The agricultural analysis application uses the leaf area index over the time-series image data to determine a growth rate of plants in the observed image data. By analyzing the entire time-series of an isolated satellite spectra, the agricultural analysis application creates a more deterministic view of crop growth from seed planting to germination to harvest. Also at step 308, the leaf area index is provided as input into a canopy reflectance simulator.

At step 310, the agricultural analysis application generates simulated satellite image data using the canopy reflectance simulator. The agricultural analysis application inputs certain parameters into the canopy reflectance simulator to generate the simulated satellite image data. In certain embodiments, the agricultural analysis application is configured to estimate input parameters into the canopy reflectance simulator such that the simulated satellite image data output of the canopy reflectance simulator is substantially similar to the satellite image data of the crop growth location that the agricultural analysis application previously identified.

At step 314, the agricultural analysis application provides the calculated leaf area index of each of the spectral bands of the real satellite image data as input into the canopy reflectance simulator in order to determine simulated canopy reflectance parameters. The output of the canopy reflectance simulator is then compared to the real satellite image data and the inputs into the canopy reflectance simulator are adjusted by the agricultural analysis application until the simulated satellite image data is substantially similar to the real satellite image data.

At step 316, the agricultural analysis application determines input parameters for a crop growth simulator that will produce an output that corresponds with at least one of the target crop growth parameters received by the agricultural analysis application. To accomplish this, the agricultural analysis application estimates initial input parameters and provides the estimated input parameters as input into the crop growth simulator. The crop growth simulator then generates simulated crop growth output based on the initial input parameters. The agricultural analysis application then compares the simulated crop growth output to the simulated canopy reflectance parameters. The agricultural analysis application modifies the initial input parameters into the crop growth simulator until it determines simulated crop growth input parameters that correspond to the target crop growth parameters.

The methodology 300 ends at step 318.

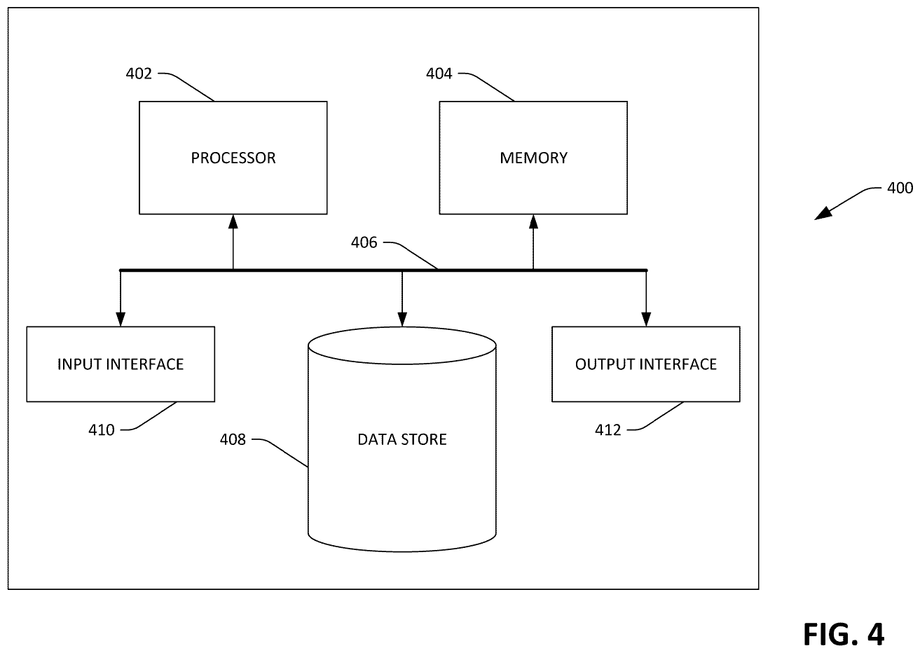

Referring now to FIG. 4, a high-level illustration of an exemplary computing device 400 that can be used in accordance with the systems and methodologies disclosed herein is illustrated. For instance, the computing device 400 may be used in a system that is configured to execute the agricultural analysis application and perform the various agricultural analysis activities as disclosed herein. The computing device 400 includes at least one processor 402 that executes instructions that are stored in a memory 404. The instructions may be, for instance, instructions for implementing functionality described as being carried out by one or more components discussed above or instructions for implementing one or more of the methods described above. The processor 402 may access the memory 404 by way of a system bus 406.

The computing device 400 additionally includes a data store 408 that is accessible by the processor 402 by way of the system bus 406. The data store 408 may include executable instructions, historical data, etc. The computing device 400 also includes an input interface 410 that allows external devices to communicate with the computing device 400. For instance, the input interface 410 may be used to receive instructions from an external computer device, from a user, etc. The computing device 400 also includes an output interface 412 that interfaces the computing device 400 with one or more external devices. For example, the computing device 400 may display text, images, etc. by way of the output interface 412.

It is contemplated that the external devices that communicate with the computing device 400 via the input interface 410 and the output interface 412 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 400 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 400 may be a distributed system. Thus, for instance, several devices may be in communication by way of a network connection and may collectively perform tasks described as being performed by the computing device 400.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium.

Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Described herein are technologies that accord to at least the following examples.
(A1) In an aspect, a method includes receiving target crop growth parameters and a crop growth location. The method also includes identifying real satellite image data of the crop growth location, wherein the real satellite image data comprises a plurality of spectral bands. The method further includes analyzing the real satellite image data to determine time-series measurements of the real satellite image data, wherein a time-series measurement comprises an observation of a spectral band of the real satellite image data over a period of time. The method additionally includes calculating a leaf area index for the plurality of spectral bands, wherein the leaf area index is based on the time-series measurements. The method also includes providing the leaf area index for the plurality of spectral bands as input into a canopy reflectance simulator, wherein the canopy reflectance simulator is configured to generate simulated satellite image data. The method further includes generating, via the canopy reflectance simulator, simulated satellite image data based on the leaf area index for the plurality of spectral bands. The method additionally includes determining simulated canopy reflectance parameters based on the real satellite image data and the simulated satellite image data, wherein the simulated canopy reflectance parameters correspond to inputs into the canopy reflectance simulator that generate simulated satellite image data that is substantially similar to the real satellite data. The method also includes determining simulated crop growth input parameters, that when provided as input into a crop growth simulator, cause the crop growth simulator to generate simulated crop growth output parameters that correspond to at least one of the target crop growth parameters, wherein the simulated crop growth input parameters are based on the simulated canopy reflectance parameters and simulated output of the crop growth simulator.
(A2) In some embodiments of the method of (A1), the target crop growth parameters comprise at least one of a crop yield, biomass, or water usage.
(A3) In some embodiments of the method of at least one of (A1)-(A2), the plurality of spectral bands comprises visible blue-green (475-575 nm), visible orange-red (580-680 nm), and visible red to near-infrared (690-830 nm).
(A4) In some embodiments of the method of at least one of (A1)-(A3), wherein the canopy reflectance simulator is based on the PROSAIL model.
(A5) In some embodiments of the method of at least one of (A1)-(A4), wherein crop growth simulator is based on the WOFOST model.
(A6) In some embodiments of the method of at least one of (A1)-(A5), determining the simulated canopy reflectance parameters further comprises providing the simulated satellite image data in the real satellite image data as input into a data assimilation module, wherein the data assimilation module is configured to adjust input into the canopy reflectance simulator until the generated satellite image data is substantially similar to the real satellite image data, wherein the generated satellite image data is substantially similar to the real satellite image data when an entire time-series measurement of the simulated satellite image data in a first spectral band matches an entire time-series measurement of the real satellite image data in a corresponding spectral band.
(A7) In some embodiments of the method of (A6), determining the simulated crop growth input parameters further comprises providing simulated crop growth output parameters and the simulated canopy reflectance parameters as input into the data assimilation module, wherein the data assimilation module is further configured to adjust input into the crop growth simulator until the simulated crop growth output parameters correspond to at least one of the target crop growth parameters.
(B1) In another aspect, a computing system includes a processor and memory that stores an agriculture analysis application that, when executed by the processor, cause the processor to perform at least one of the methods disclosed herein (e.g., any of the methods of (A1)-(A7)).
(C1) In yet another aspect, a computer-readable storage medium includes an agricultural analysis application that, when executed by a processor, cause the agriculture analysis application to perform at least one of the methods disclosed herein (e.g., any of the methods of (A1)-(A7)).

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computing system comprising:
a processor; and
memory storing an agriculture analysis application that, when executed by the processor, causes the agriculture analysis application to perform acts comprising:
receiving target crop growth parameters and a crop growth location;
identifying real satellite image data of the crop growth location, wherein the real satellite image data comprises a plurality of spectral bands;
analyzing the real satellite image data to determine time-series measurements of the real satellite image data, wherein a time-series measurement comprises an observation of a spectral band of the real satellite image data over a period of time;
calculating a leaf area index for the plurality of spectral bands, wherein the leaf area index is based on the time-series measurements;
providing the leaf area index for the plurality of spectral bands as input into a canopy reflectance simulator, wherein the canopy reflectance simulator is configured to generate simulated satellite image data;
generating, via the canopy reflectance simulator, simulated satellite image data based on the leaf area index for the plurality of spectral bands;
determining simulated canopy reflectance parameters based on the real satellite image data and the simulated satellite image data, wherein the simulated canopy reflectance parameters correspond to inputs into the canopy reflectance simulator that generate simulated satellite image data that is substantially similar to the real satellite data; and
determining simulated crop growth input parameters, that when provided as input into a crop growth simulator, cause the crop growth simulator to generate simulated crop growth output parameters that correspond to at least one of the target crop growth parameters, wherein the simulated crop growth input parameters are based on the simulated canopy reflectance parameters and simulated output of the crop growth simulator.

2. The system of claim 1, wherein the target crop growth parameters comprise at least one of a crop yield, biomass, or water usage.

3. The system of claim 1, wherein the plurality of spectral bands comprises visible blue-green (475-575 nm), visible orange-red (580-680 nm), and visible red to near-infrared (690-830 nm).

4. The system of claim 1, wherein the canopy reflectance simulator is based on the PROSAIL model.

5. The system of claim 1, wherein crop growth simulator is based on the WOFOST model.

6. The system of claim 1, wherein determining the simulated canopy reflectance parameters further comprises providing the simulated satellite image data in the real satellite image data as input into a data assimilation module, wherein the data assimilation module is configured to adjust input into the canopy reflectance simulator until the generated satellite image data is substantially similar to the real satellite image data, wherein the generated satellite image data is substantially similar to the real satellite image data when an entire time-series measurement of the simulated satellite image data in a first spectral band matches an entire time-series measurement of the real satellite image data in a corresponding spectral band.

7. The system of claim 6, wherein determining the simulated crop growth input parameters further comprises providing simulated crop growth output parameters and the simulated canopy reflectance parameters as input into the data assimilation module, wherein the data assimilation module is further configured to adjust input into the crop growth simulator until the simulated crop growth output parameters correspond to at least one of the target crop growth parameters.

8. The system of claim 1, wherein the target crop growth parameters are based on a persona.

9. A method comprising:
receiving target crop growth parameters and a crop growth location;
identifying real satellite image data of the crop growth location, wherein the real satellite image data comprises a plurality of spectral bands;
analyzing the real satellite image data to determine time-series measurements of the real satellite image data, wherein a time-series measurement comprises an observation of a spectral band of the real satellite image data over a period of time;
calculating a leaf area index for the plurality of spectral bands, wherein the leaf area index is based on the time-series measurements;
providing the leaf area index for the plurality of spectral bands as input into a canopy reflectance simulator, wherein the canopy reflectance simulator is configured to generate simulated satellite image data;
generating, via the canopy reflectance simulator, simulated satellite image data based on the leaf area index for the plurality of spectral bands;
determining simulated canopy reflectance parameters based on the real satellite image data and the simulated satellite image data, wherein the simulated canopy reflectance parameters correspond to inputs into the canopy reflectance simulator that generate simulated satellite image data that is substantially similar to the real satellite data; and
determining simulated crop growth input parameters, that when provided as input into a crop growth simulator, cause the crop growth simulator to generate simulated crop growth output parameters that correspond to at least one of the target crop growth parameters, wherein the simulated crop growth input parameters are based on the simulated canopy reflectance parameters and simulated output of the crop growth simulator.

10. The method of claim 9, wherein the target crop growth parameters comprise at least one of a crop yield, biomass, or water usage.

11. The method of claim 9, wherein the plurality of spectral bands comprises visible blue-green (475-575 nm), visible orange-red (580-680 nm), and visible red to near-infrared (690-830 nm).

12. The method of claim 9, wherein the canopy reflectance simulator is based on the PROSAIL model.

13. The method of claim 9, wherein crop growth simulator is based on the WOFOST model.

14. The method of claim 9, wherein determining the simulated canopy reflectance parameters further comprises providing the simulated satellite image data in the real satellite image data as input into a data assimilation module, wherein the data assimilation module is configured to adjust input into the canopy reflectance simulator until the generated satellite image data is substantially similar to the real satellite image data, wherein the generated satellite image data is substantially similar to the real satellite image data when an entire time-series measurement of the simulated satellite image data in a first spectral band matches an entire time-series measurement of the real satellite image data in a corresponding spectral band.

15. The method of claim 14, wherein determining the simulated crop growth input parameters further comprises providing simulated crop growth output parameters and the simulated canopy reflectance parameters as input into the data assimilation module, wherein the data assimilation module is further configured to adjust input into the crop growth simulator until the simulated crop growth output parameters correspond to at least one of the target crop growth parameters.

16. A computer-readable storage medium comprising an agriculture analysis application that, when executed by a processor, cause the agriculture analysis application to perform acts comprising:
receiving target crop growth parameters and a crop growth location;
identifying real satellite image data of the crop growth location, wherein the real satellite image data comprises a plurality of spectral bands;
analyzing the real satellite image data to determine time-series measurements of the real satellite image data, wherein a time-series measurement comprises an observation of a spectral band of the real satellite image data over a period of time;
calculating a leaf area index for the plurality of spectral bands, wherein the leaf area index is based on the time-series measurements;
providing the leaf area index for the plurality of spectral bands as input into a canopy reflectance simulator, wherein the canopy reflectance simulator is configured to generate simulated satellite image data;
generating, via the canopy reflectance simulator, simulated satellite image data based on the leaf area index for the plurality of spectral bands;
determining simulated canopy reflectance parameters based on the real satellite image data and the simulated satellite image data, wherein the simulated canopy reflectance parameters correspond to inputs into the canopy reflectance simulator that generate simulated satellite image data that is substantially similar to the real satellite data; and
determining simulated crop growth input parameters, that when provided as input into a crop growth simulator, cause the crop growth simulator to generate simulated crop growth output parameters that correspond to at least one of the target crop growth parameters, wherein the simulated crop growth input parameters are based on the simulated canopy reflectance parameters and simulated output of the crop growth simulator.

17. The computer-readable storage medium of claim 16, wherein the target crop growth parameters comprise at least one of a crop yield, biomass, or water usage.

18. The computer-readable storage medium of claim 17, wherein the canopy reflectance simulator is based on the PROSAIL model and the crop growth simulator is based on the WOFOST model.

19. The computer-readable storage medium of claim 18, wherein determining the simulated canopy reflectance parameters further comprises providing the simulated satellite image data in the real satellite image data as input into a data assimilation module, wherein the data assimilation module is configured to adjust input into the canopy reflectance simulator until the generated satellite image data is substantially similar to the real satellite image data.

20. The computer-readable storage medium of claim 19, wherein determining the simulated crop growth input parameters further comprises providing simulated crop growth output parameters and the simulated canopy reflectance parameters as input into the data assimilation module, wherein the data assimilation module is further configured to adjust input into the crop growth simulator until the simulated crop growth output parameters correspond to at least one of the target crop growth parameters.
